(19) United States
(12) Patent Application Publication
(10) Pub. No.: US 2003/0187954 A1
(43) Pub. Date: Oct. 2, 2003

(54) Method and apparatus for downloading e-book via WAP

(75) Inventors: Shih-Jen Wen, Taipei Hsieng (TW); Shih-Kuang Tsai, Taipei Hsieng (TW); Wen-Chiang Chin, Shanghai City (CN); Hua-Feng Mai, Shanghai City (CN); Pei-Chih Li, Shanghai City (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsieng (TW)

(21) Appl. No.: 10/108,509

(22) Filed: Mar. 29, 2002

(51) Int. Cl. G06F 15/16

(52) U.S. Cl. 709/219; 709/230

(57) ABSTRACT

The present invention relates to method and apparatus for downloading an e-book via a portable electronic device in communication with a hypertext transfer protocol (HTTP) server over the Internet, the method comprises activating a wireless application protocol (WAP) browser to enter into an e-book Web site provided by an Internet service provider (ISP); displaying a pane containing an e-book catalog option sent from the e-book Web site on a display of the electronic device; reading the catalog option selected on the display for retrieving an e-book catalog; sending the retrieved catalog to the WAP browser prior to showing the same on the display; reading a name of e-book selected from the e-book catalog; downloading the selected e-book; and storing the downloaded e-book in a memory of the electronic device for offline reading.

### FIELD OF THE INVENTION

The present invention relates to wireless application protocol (WAP) and more particularly to method and apparatus for downloading e-book via WAP.

### BACKGROUND OF THE INVENTION

Semiconductor and network communication technologies have known a rapid and a spectacular development leading to an increasing use of portable electronics (e.g., personal digital assistance (PDA), cellular phones, or the like). Recently, there is a trend of developing slim, portable electronics among electronic product manufacturers. Further, the functions of such an electronic product may incorporate features of many other consumer electronic products to form a multifunctional one. For example, a cellular phone can become one having PDA feature once PDA feature is incorporated therein. In detail, such cellular phone has the features of, in addition to voice communication, connecting to server of the Internet for downloading information therefrom or uploading information thereto due to the installation of modem and network communication software therein. In other words, the cellular phone has the capability of accessing to the Internet.

In recent years, a WAP is developed and installed in many portable electronic products by the electronic product manufacturers. Hence, a device having WAP feature enables a user to connect to the Internet for retrieving information such as latest news, stock market, etc. Accordingly, WAP has become a standard built-in software for many portable electronic products.

However, the prior art suffered from a disadvantage. For example, a user can only view at most 1,500 characters of a document at one time on an electronic product having WAP feature. This is because WAP can only process short messages. This means that only limited information can be retrieved via WAP on such electronic product. Further, user usually has to connect to the Internet continually for retrieving sufficient information. As a result, many users are not interested in using an electronic product having WAP feature for connecting to the Internet due to the above reasons (i.e., slow browsing speed and limited information). This is a waste.

In the other aspect, since the booming of the Internet which connects the local are networks (LANs) of thousands of firms, universities and other organizations, information from millions of sources are available for retrieving. Moreover, life of people throughout the world has been improved significantly due to the progress of technologies in these several decades. In addition to enough food, more and more people desire to learn more. As such, incomplete information available from the Internet does not satisfy such people. Thus, books are viewed by many people as a good information source. Above electronic product having WAP feature provides new means for retrieving information from the Internet. However, as stated above, the same drawbacks such as slow browsing speed and limited information still exist when user uses an electronic product having WAP feature to preview e-book catalog on the Internet.

Thus, it is desirable to provide novel means for quickly downloading e-book from the Internet via WAP by modifying existing electronic products having WAP feature in order to overcome the above drawbacks of prior art.

### SUMMARY OF THE INVENTION

It is therefore an object of the present invention to provide a method for downloading an e-book via an apparatus including a portable electronic device having a wireless application protocol (WAP) browser which is in data communication with a hypertext transfer protocol (HTTP) server over the Internet, the method comprises activating the WAP browser to enter into an e-book Web site provided by an Internet service provider (ISP); displaying a pane containing an e-book catalog option sent from the e-book Web site on screen of a display of the electronic device; reading the e-book catalog option selected by user on screen of the display of the electronic device for retrieving an e-book catalog; sending the retrieved e-book catalog to the WAP browser prior to showing the same on screen of the display of the electronic device; reading a name of e-book selected by user from the e-book catalog on screen of the display of the electronic device; downloading the selected e-book; and storing the downloaded e-book in a memory of the electronic device for offline reading.

In one aspect of the present invention, the method further comprises the steps of diving the selected e-book to be downloaded into a plurality of continuous packets each having a predetermined memory and corresponding to a unique chapter or one or more paragraphs of the chapter of the e-book; converting a first page of each packet into a WAP based Web page prior to sending to the WAP browser; assembling all received WAP based Web pages into a complete e-book; and storing the complete e-book in a memory of the electronic device.

In another aspect of the present invention, the method further comprises the step of adding a bookmark into each e-book to be downloaded so that when reading an e-book, the bookmark is automatically pointed to a last visited page (if any) of the e-book. Hence, much time is saved since user does not need to search the last visited page of the e-book by scrolling the screen.

It is another object of the present invention to provide an apparatus for downloading e-book via WAP comprising a portable electronic device having a WAP browser; a network server; and a WAP gateway interconnecting the network server and the electronic device; wherein the WAP browser is operative to activate to enter into an e-book Web site provided by an ISP via the network server, a pane containing an e-book catalog option sent from the e-book Web site is shown on a display of the electronic device, the e-book catalog option on the display of the electronic device is selected for retrieving an e-book catalog, the retrieved e-book catalog is sent to the WAP browser prior to showing the same on the display of the electronic device, a name of e-book is selected by user from the e-book catalog on the display of the electronic device, the selected e-book is downloaded prior to being divided into a plurality of continuous packets each having a predetermined memory and corresponding to a unique chapter or one or more paragraphs of the chapter of the e-book, a first page of each packet is converted into a WAP based Web page prior to sending to the WAP browser, in response to all WAP based Web pages received by the WAP browser the decoded e-book is assembled into a complete e-book, and the complete e-book is stored in a memory of the electronic device.

The above and other objects, features and advantages of the present invention will become apparent from the following detailed description taken with the accompanying drawings.

### BRIEF DESCRIPTION OF THE DRAWINGS

FIG. 1 presents schematically a flow chart of a portable electronic device according to the invention in obtaining Web pages about e-book catalog and contents of e-book(s) by using WAP;

FIG. 2 is a flow chart illustrating processes performed by WAP browser and HTTP server of FIG. 1 respectively;

FIG. 3A illustrates an initial screen of a display of the FIG. 2 electronic device;

FIG. 3B shows an e-book catalog option display of the dispaly, shown following user selection at FIG. 2; and

FIGS. 4A, 4B and 4C show exemplary e-book option displays respectively, shown following user selection at FIG. 2.

### DETAILED DESCRIPTION OF THE PREFERRED EMBODIMENTS

The invention is directed to method and apparatus for downloading e-book via WAP. As to the method for downloading an e-book via an apparatus including a portable electronic device having a wireless application protocol (WAP) browser which is in data communication with a hypertext transfer protocol (HTTP) server over the Internet, the method comprises activating the WAP browser to enter into an e-book Web site provided by an Internet service provider (ISP); displaying a pane containing an e-book catalog option sent from the e-book Web site on screen of a display of the electronic device; reading the e-book catalog option selected by user on screen of the display of the electronic device for retrieving an e-book catalog; sending the retrieved e-book catalog to the WAP browser prior to showing the same on screen of the display of the electronic device; reading a name of e-book selected by user from the e-book catalog on screen of the display of the electronic device; downloading the selected e-book; and storing the downloaded e-book in a memory of the electronic device for offline reading.

In the portable electronic device, a WAP browser is employed to read files (e.g., Web pages) created by wireless markup language (WML) over the internet. Such file comprises at least one hyperlink for combining a plurality of elements (e.g., text, graphics, images or the like) of a plurality of hypertext documents into a set. Each hyperlink comprises a packet for storing up to 1,500 characters. Thus, it is possible of overcoming a known limitation on size of a file sent by WAP by dividing a selected file (e.g., e-book) into a plurality of continuous packets. In other words, an e-book having large volume can also be quickly downloaded over the Internet.

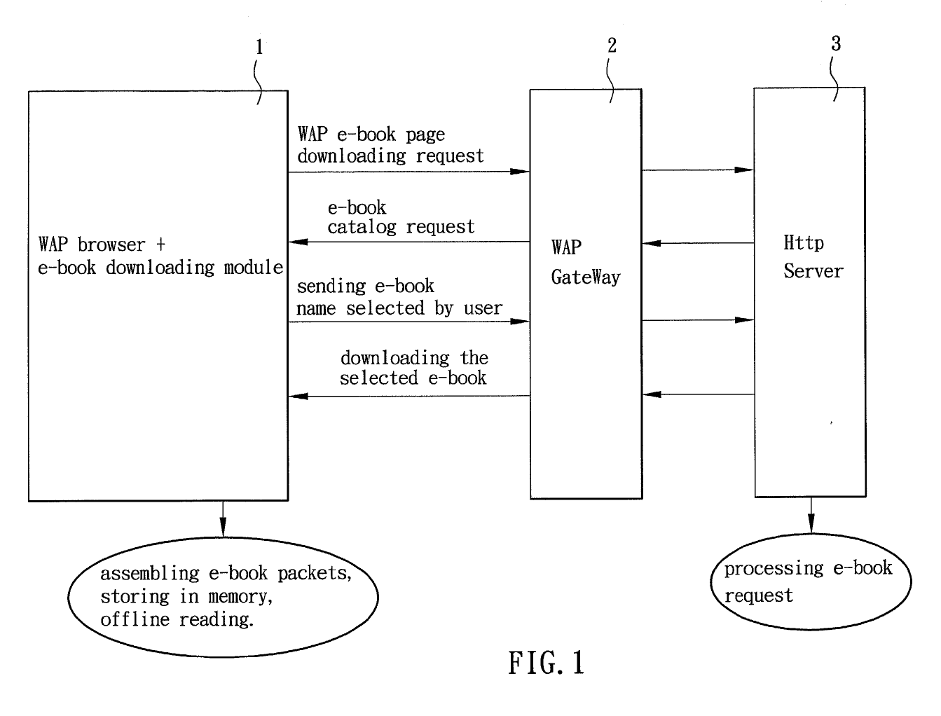

Referring to FIG. 1, it presents schematically a flow chart of a portable electronic device according to an apparatus of the invention in obtaining Web pages about e-book catalog and contents of e-book(s) by using WAP. As shown, the electronic device of the apparatus comprises a WAP browser 1 which is in data communication with a HTTP server 3 via a WAP gateway 2. In use, user can activate WAP browser 1 to enter into an e-book Web site provided by an Internet service provider (ISP) via HTTP server 3. Then a pane containing an e-book catalog option sent from the e-book Web site is displayed on screen of a display of the electronic device. Next user can select a menu option (i.e., the e-book catalog option) on the screen of display of the electronic device for retrieving an e-book catalog. In response, the retrieved e-book catalog is sent to WAP browser 1 via HTTP server 3 prior to showing on screen of display of the electronic device for reference. Next, user can select a desired item (i.e., name of an e-book) from the e-book catalog by clicking on display of the electronic device. In response, the selected e-book is downloaded via HTTP server 3. Note that the downloaded e-book is divided (i.e., encoded) into a plurality of continuous packets each having a memory for storing up to 1,500 characters and corresponding to a unique chapter or one or more paragraphs of a chapter of the e-book. Also, first page of each packet is converted into a WAP based Web page prior to sending to WAP browser 1. After all WAP based Web pages are received by WAP browser 1, a decoding (i.e., assembling) of the paragraphs and chapters of the e-book is performed based on a predetermined rule. Next, the decoded HTTP server is either stored in a memory of the electronic device or shown on the display of the electronic device.

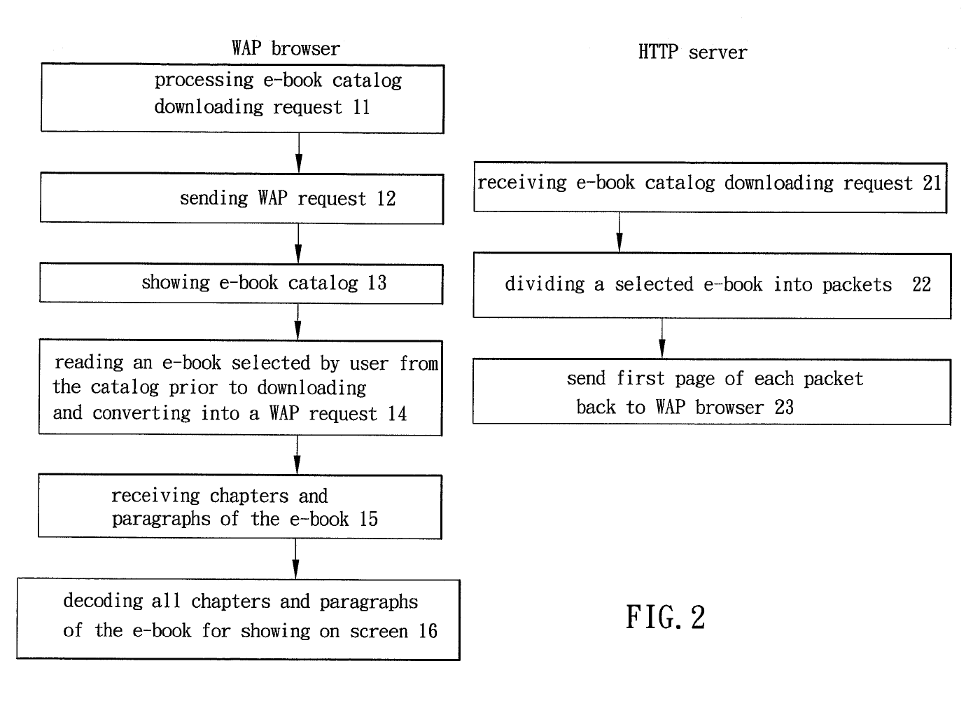

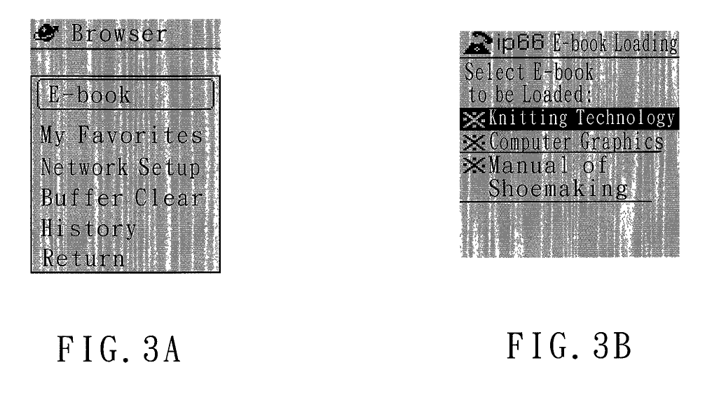

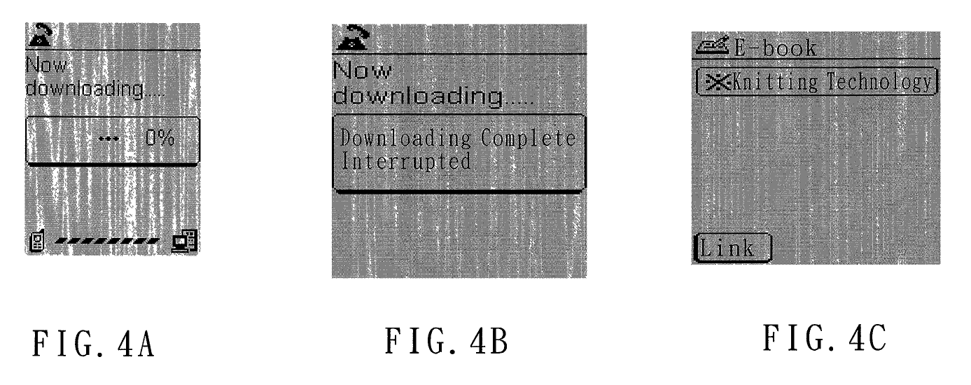

Referring to FIG. 2 in conjunction with FIGS. 3 and 4, a flow chart illustrates processes performed by WAP browser 1 and HTTP server 3 of FIG. 1 respectively. As respect to WAP browser 1, first, user may use WAP browser 1 of the electronic device to connect to the Internet via HTTP server 3. Once connected, an e-book option at an e-book Web site is shown (FIG. 3A). Following is a description of a flow chart performed by WAP browser 1 in response to a selection of an e-book option of FIG. 3A:

In step 11, process an e-book catalog downloading requested by user.

In step 12, convert the e-book catalog downloading request into a WAP request prior to sending the WAP request for a reply (i.e., e-book catalog menu) from HTTP server 3.

In step 13, once the e-book catalog menu is received by WAP browser 1, show the e-book catalog menu on a screen of display of the electronic device (FIG. 3B). As shown in FIG. 3B, the e-book catalog menu comprises three e-books (i.e., available e-books from the e-book Web site).

In step 14, read one of e-books selected by user from the e-book catalog menu. Then, download the selected e-book from the Internet prior to converting into a WAP request (FIG. 4A).

In step 15, sent chapters and paragraphs of the selected e-book sequentially back via HTTP server 3.

In step 16, after all chapters and paragraphs of the selected e-book have been downloaded, automatically interrupt a connection to the Internet (FIG. 4B). At the same time, store all chapters and paragraphs of the selected e-book into memory of the electronic device. Further, perform a decoding of the paragraphs and chapters of the e-book based on a predetermined rule. Next, show the decoded (i.e., assembled) e-book on the display of the electronic device. A name of the e-book is shown in FIG. 4C. Thus, user may choose to read the e-book by an offline technique.

Referring to FIG. 2 again, a process performed by HTTP server 3 is also illustrated.

In step 21, receive an e-book catalog downloading request from WAP browser 1. Then send the same into WAP browser 1.

In step 22, divide (i.e., encode) a selected e-book into a plurality of continuous packets each having a memory for storing up to 1,500 characters and corresponding to a unique chapter or one or more paragraphs of a chapter of the e-book.

In step 23, send first page of each packet of the e-book back to WAP browser 1.

In another embodiment of the invention, a bookmark is added into each e-book to be downloaded. When reading an e-book, the bookmark is automatically pointed to a last visited page (if any) of the e-book. Hence, a lot of time is saved since user does not need to search the last visited page of the e-book (i.e., scrolling the screen).

In brief, the invention, with the aid of HTTP server 3, enables WAP browser 1 to divide a selected e-book into a plurality of continuous packets each having a memory for storing up to 1,500 characters and corresponding to a unique chapter or one or more paragraphs of a chapter of the e-book. As such, a known limitation on size of an document sent by WAP is eliminated. In other words, an e-book having large volume can also be quickly downloaded over the Internet. As an end, user will really like to read e-books by using the portable electronic device.

While the invention has been described by means of specific embodiments, numerous modifications and variations could be made thereto by those skilled in the art without departing from the scope and spirit of the invention set forth in the claims.

What is claimed is:

1. A method for downloading an e-book via an apparatus including a portable electronic device having a wireless application protocol (WAP) browser which is in data communication with a network server over the Internet, the method comprising the steps of:
activating the WAP browser to enter into an e-book Web site provided by an Internet service provider (ISP);
displaying a pane containing an e-book catalog option sent from the e-book Web site on a display of the electronic device;
reading the e-book catalog option selected by user on the display of the electronic device for retrieving an e-book catalog;
sending the retrieved e-book catalog to the WAP browser prior to showing the same on the display of the electronic device;
reading a name of e-book selected by user from the e-book catalog on the display of the electronic device;
downloading the selected e-book; and
storing the downloaded e-book in a memory of the electronic device for offline reading.

2. The method of claim 1, wherein in response to the entering of the e-book Web site by the WAP browser, further comprising the steps of:
processing an e-book catalog downloading requested by user;
converting the e-book catalog downloading request into a WAP request;
sending the WAP request for retrieving the e-book catalog menu from the network server;
receiving the e-book catalog menu by the WAP browser prior to displaying the same on the display of the electronic device;
reading one of the e-books selected by user from the e-book catalog menu prior to downloading and converting the same into the WAP request;
receiving chapters and paragraphs of the selected e-book which are sequentially sent back via the network server; and
storing all received chapters and paragraphs of the selected e-book in the memory of the electronic device.

3. The method of claim 2, wherein in response to the downloading requested by the WAP browser, further comprising the steps of decoding the paragraphs and the chapters of the e-book based on a predetermined rule; assembling the decoded e-book into a complete e-book; and displaying the complete e-book on the display of the electronic device for offline reading.

4. The method of claim 2, wherein a process performed by the network server comprises the steps of:
receiving the e-book catalog downloading request from the WAP browser prior to sending the same into the WAP browser;
dividing the selected e-book into a plurality of continuous packets each corresponding to a unique chapter or one or more paragraphs of the chapter of the e-book; and
sending a first page of each packet of the e-book back to the WAP browser.

5. The method of claim 1, further comprising the step of adding a bookmark into each e-book to be downloaded.

6. The method of claim 1, wherein the network server is a hypertext transfer protocol (HTTP) server.

7. An apparatus for downloading e-book via WAP comprising:
a portable electronic device having a WAP browser;
a network server; and
a WAP gateway interconnecting the network server and the electronic device;
wherein the WAP browser is operative to activate to enter into an e-book Web site provided by an ISP via the network server, a pane containing an e-book catalog option sent from the e-book Web site is shown on a display of the electronic device, the e-book catalog option on the display of the electronic device is selected for retrieving an e-book catalog, the retrieved e-book catalog is sent to the WAP browser prior to showing the same on the display of the electronic device, a name of e-book is selected by user from the e-book catalog on the display of the electronic device, the selected e-book is downloaded prior to being divided into a plurality of continuous packets each having a predetermined memory and corresponding to a unique chapter or one or more paragraphs of the chapter of the e-book, a first page of each packet is converted into a WAP based Web page prior to sending to the WAP browser, in response to all WAP based Web pages received by the WAP browser the decoded e-book is assembled into a complete e-book, and the complete e-book is stored in a memory of the electronic device.

8. The apparatus of claim 7, wherein the network server is a hypertext transfer protocol (HTTP) server.
